(19) United States
(12) Patent Application Publication
(10) Pub. No.: US 2013/0134928 A1
(43) Pub. Date: May 30, 2013

(54) ELECTRICAL STORAGE SYSTEM AND RECHARGEABLE BATTERY STORAGE SYSTEM RACK

(71) Applicant: Sanyo Electric Co., Ltd., Moriguchi City (JP)

(72) Inventors: Kenji Uchihashi, Osaka (JP); Hiroto Nagano, Osaka (JP); Yoshiyuki Ishizuka, Osaka (JP)

(73) Assignee: Sanyo Electric Co., Ltd., Moriguchi City (JP)

(21) Appl. No.: 13/749,912

(22) Filed: Jan. 25, 2013

Related U.S. Application Data
(63) Continuation of application No. PCT/JP2011/067349, filed on Jul. 28, 2011.

(30) Foreign Application Priority Data
Jul. 30, 2010 (JP) 2010-172111

(51) Int. Cl. H02J 7/00

(52) U.S. Cl. CPC H02J 7/0042
USPC 320/107

(57) ABSTRACT

An electrical storage system with a plurality of rechargeable battery storage system racks (10) containing rechargeable batteries (140) and a circuit block (40) in a storage main unit (12) wherein each of storage main units (12) of the rechargeable battery storage system racks (10) has a fire resistant insulating plate material provided on an inner side of a wall surface that contacts at outer wall surface of another rechargeable battery storage system rack (10). With an electrical storage system (250) where rechargeable battery storage system racks (10) are arranged in two rows, the storage main unit (12) of each rechargeable battery storage system rack (10) has a fire resistant insulating material plate (160), (162), (164) provided on the inner side of the left wall surface, right wall surface, and back wall surface.

### FIELD OF THE INVENTION

The present invention relates to an electrical storage system and to a rechargeable battery storage system rack, and in particular relates to an electrical storage system wherein a plurality of rechargeable battery storage system racks containing circuit devices and rechargeable batteries are arranged.

### BACKGROUND

By using electrical storage devices such as rechargeable batteries and the like, energy can be effectively utilized. For example, development of solar electricity generating systems has been proceeding as a green energy that is friendly to the environment, but the photoelectric conversion modules that convert solar light to electrical power did not have an electrical storage function, so these devices are used in conjunction with a rechargeable battery. For example, energy is effectively utilized by charging and discharging control that uses the power generated by the photoelectric conversion module to first charge a rechargeable battery, and then discharging from the rechargeable battery based on demand at the like for an external load.

The rechargeable battery can be a lithium ion rechargeable battery for example. A rechargeable battery is used for long periods of time in various types of environments, and therefore preferably has various safety measures. Furthermore, although various safety measures are provided in the lithium ion rechargeable battery cells and the like, safety is preferably enhanced when rechargeable batteries are stored and used in a rack or the like.

For example, patent document 1 discloses a configuration of a power source device with a plurality of batteries stored in a case, wherein the case has a partition wall that partitions a battery chamber that stores a plurality of batteries, and a ventilation chamber that simulates gas discharged from a safety valve on the batteries stored in the battery chamber. Herein, a configuration that provides a fire extinguisher that injects an extinguishing agent or an inert fluid into the ventilation chamber, and a pressure sensor that detects the pressure in the ventilation chamber, wherein the fire extinguisher is controlled by the pressure sensor, and when the pressure in the ventilation chamber exceeds a set pressure, the fire extinguisher injects extinguishing agent or inner fluid into the ventilation chamber.

### BACKGROUND ART DOCUMENTS

Patent Documents

Patent Reference 1 Japanese Unexamined Patent 2007-27011

### SUMMARY OF THE INVENTION

### Problem to be Resolved by the Invention

Incidentally, there are cases where the charge discharge capacity of a single power source device is insufficient based on the specification of the load machines, and in these cases, a plurality of power source devices are used. Alternatively, when a single plant facility or the like has a plurality of load machines, gathering the power source devices required for these load machines in a single location is convenient for controlling. In this case, a plurality of power source devices can be gathered and arranged in a single location to form a power source set.

With the configuration of patent document 1, abnormalities are monitored and extinguishing agent is injected when needed for a single power source device that stores a plurality of rechargeable batteries, but no consideration has been made for the case where a plurality of power source devices are provided. Therefore, with the method of patent document 1, abnormality countermeasures when a plurality of power source devices are provided may be insufficient, so further safety improvements are desirable.

An object of the present invention is to provide a rechargeable battery storage system that can suppress negative effect on adjacent rechargeable battery storage system racks even when an abnormality such as heating or the like occurs in a single rechargeable battery storage system rack, when a plurality of rechargeable battery storage system racks are arranged.

### Means for Resolving Problems

The electrical storage system of the present invention is an electrical storage system with a plurality of rechargeable battery storage system racks containing rechargeable batteries and a circuit block that controls charging and discharging of the rechargeable batteries; wherein each of storage main units of the rechargeable battery storage system racks that compose the plurality of rechargeable battery storage racks that are arranged has a plate material placed by a predetermined placement method on an inner side of a contacting wall surface which is a wall surface of the rechargeable battery storage system rack that contacts the outer wall surface of a second rechargeable battery storage system rack that is adjacent to the rechargeable battery storage system rack.

Furthermore, the rechargeable battery storage system rack of the present invention contains a rechargeable battery, a circle block that controls charging and discharging of the rechargeable battery, and a storage main unit that stores the rechargeable battery and the circuit block, wherein an opening and closing door it is provided in one of the outer wall surfaces of the four outer wall surfaces, the outer wall surface where the opening and closing door is provided is the front surface, the outer wall surface on the opposite side as the front surface is the back surface, the outer wall surface on the left side when facing the front surface is the left wall surface, and the outer wall surface on the right side when facing the front surface is the right wall surface, and the plate material is provided on the inside of at least one outer wall surface of the back wall surface, left wall surface, and right wall surface.

### Effect of the Invention

With the present invention, if a plurality of rechargeable battery storage system racks are arranged, a plate material is placed on the inner side of the contacting surfaces which are the that contact the outside wall surface of a second rechargeable battery storage system rack, in the storage main unit of each rechargeable battery storage system rack, and therefore if an abnormality such as heating or the like occurs in one of the rechargeable battery storage system racks, the effect on the adjacent rechargeable battery storage system racks can be suppressed.

### BRIEF DESCRIPTION OF THE DRAWINGS

FIG. 1 is a diagram illustrating the front surface view and the top surface view of one rechargeable battery storage system rack when the front surface door is closed.

FIG. 2 is a diagram illustrating the front surface view and the top surface view of one rechargeable battery storage system rack when the front surface door is open.

FIG. 3 is a diagram describing the placement condition for the flameproof insulation material, when a plurality of rechargeable battery storage system racks are arranged in a lateral row.

FIG. 4 is a diagram describing an example where the placement of the fireproof insulation board in FIG. 3 can be partially omitted.

FIG. 5 is a diagram describing the placement condition for the flameproof insulation material, when a plurality of rechargeable battery storage system racks are arranged in two rows.

FIG. 6 is a diagram describing an example where the placement of the fireproof insulation board in FIG. 5 can be partially omitted.

### DETAILED DESCRIPTION OF THE PREFERRED EMBODIMENTS

Using the diagram, an embodiment of the present invention is described below. A lithium ion battery pack is described below as a rechargeable battery, but other types of batteries that generate heat by an electrochemical reaction and that can discharge and charge are applicable. For example, nickel hydrogen battery packs, nickel cadmium battery packs, manganese battery packs, and the like are applicable. A battery pack combines single cells to obtain a desired high voltage. Therefore, the number of single cells composing the battery pack can be an appropriately selected battery pack based on the specification.

Furthermore, a calcium silicate board is described which is a fireproof board of insulation material, but boards, other than the one described above, with material properties having appropriate strength, appropriate insulation properties, and appropriate fire resistance are also applicable. For example, a ceramic board with appropriate material properties is also possible.

Furthermore, the dimension, shape, materials, and the like stated below are examples for explanation, and appropriate modifications based on the specification of the rechargeable battery storage system rack are possible. For example, the number of rechargeable batteries stored in the rechargeable block, the number of fireproof boards of insulation material, the number of rechargeable battery storage system racks composing the storage system, and the like stated below are examples.

Furthermore, identical elements in every diagram are assigned the same symbol, and duplicate descriptions are omitted. Furthermore, descriptions in the body will use descriptions that have a symbol stated before, if necessary.

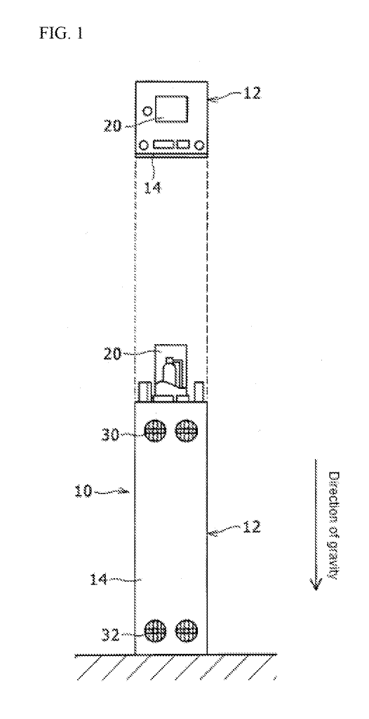

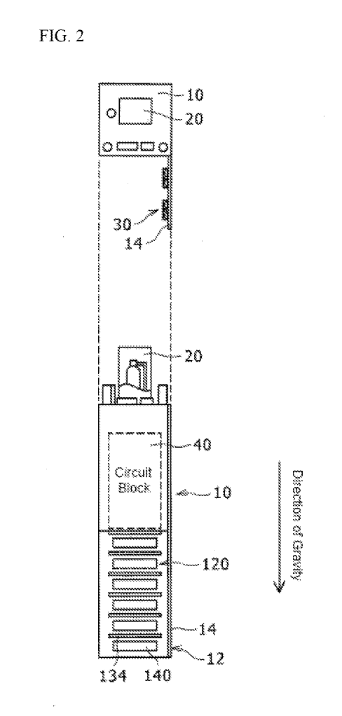

FIG. 1 is a diagram illustrating a front view and a top view of a rechargeable battery storage system rack 10 when the front surface door 14 is closed. FIG. 2 is a diagram illustrating a front view and a top view of the rechargeable battery storage system rack 10 when the front surface door 14 is open. The rechargeable battery storage system rack 10 includes a storage main unit 12 and a fire extinguisher 20. Furthermore, at this point, the configuration of a rechargeable battery storage system rack 10 that can be used individually, without considering the effect on the periphery. As described below, if several rechargeable battery storage system racks 10 are combined and used as a set, the configuration becomes one that considers the effect on the adjacent rechargeable battery system racks 10.

The storage main unit 12 functions as a rack that internally stores a circuit block 40 and a rechargeable battery block 120 composed of several rechargeable batteries 140.

The storage main unit 12 has an elongated box shape in the horizontal direction, has a bottom surface that is essentially square in shape and is connected to the insulation surface, and is surrounded by three side wall members as an outer wall; and the remaining wall is the openable and closable front surface door 14. Here, the vertical direction is illustrated as the gravitational direction G, as illustrated in FIG. 1 and FIG. 2.

Furthermore, the side wall members and front surface door 14 are made using material that has adequate strength such as stainless steel for example. As an example of dimensions, the base is approximately 70 cm×approximately 70 cm, and the height is approximately 240 cm. Furthermore, a height measurement of the fire extinguisher 20 is approximately 50 cm. Naturally, dimensions other than these are possible.

The fire extinguisher 20 provided on the top side of the top part of the storage body part 12 is a fire extinguisher that has a function for providing an extinguishing agent when a fire needs to be extinguished in the rechargeable battery block 120.

An intake fan part 32 established on the bottom part of the front surface door 14 of the storage main body 12 has a function that takes air from outside of the rechargeable battery storage system rack 10 to the inside. Furthermore, an exhaust fan part 30 established on the top part of the front surface door 14 has a function that ventilates air from inside of the rechargeable battery storage system rack 10 to the outside. The intake fan part 32 and the ventilation fan part 30 are made with an opening established on each front door 14 and a fan installed onto the front door 14, in addition to the opening. Operations of the intake fan part 32 and the ventilation fan part 30 are controlled by the circuit block 40.

The circuit block that is stored inside the storage main unit 12 is configured with a power distributor unit, a control unit, and a breaker unit.

Herein, the power distributor unit has a function that receives external power and converts the power to a suitable alternating current power in order to charge each of the rechargeable batteries 140 of the rechargeable battery block 120 by either voltage conversion or AC/DC conversion or the like, and a function that converts power in order to provide power to an external load by either voltage conversion or AC/DC conversion or the like of the power released from the rechargeable battery block 120.

Furthermore, the control unit has a charge and discharge control function that controls the operation of the power distributor unit based on charge and discharge commands sent from an external part. Furthermore, the fire extinguishing control function has a function that controls the operation of the fire extinguishing device 20 and stops operation of the intake fan 32 and the ventilation fan 30 during operation of the fire extinguishing device 20.

Furthermore, the breaker unit has a function that interrupts charge and discharge power between the power distributor unit and the rechargeable battery block 120 based on control by the control unit.

The rechargeable battery block 120 is configured to include a plurality of rechargeable batteries 140, and a plurality of fireproof insulation boards 134 placed between each of the rechargeable batteries 140. The plurality of rechargeable batteries 140 and the plurality of fireproof insulation boards 134 are alternatingly arranged in the vertical direction in the direction of gravity by an appropriate supporting member not shown in the drawings. In the example of FIG. 2, six rechargeable batteries 140 and six fireproof insulation boards 134 are alternatingly provided in the vertical direction in the direction of gravity.

The rechargeable battery 140 is a lithium ion battery pack containing a battery pack case at a plurality of lithium ion cells stored therein.

The fireproof insulation board 134 is a board for thermally segregating adjacent rechargeable batteries 140. Specifically, calcium silicate which has excellent fire resistance, thermal insulating effects, and strength is used. The fireproof insulation board 134 is a shielding flat board that has gas barrier properties in the thickness direction of the board and does not have openings such as machine holes or the like, so that if fire will not have an effect on an adjacent rechargeable battery 140 in the event that a fire occurs in one of the rechargeable batteries 140.

In this manner, even if abnormal heating occurs in one of the plurality of rechargeable batteries 140 inside one of the rechargeable battery storage system racks 10, the abnormal heating will be stopped at that rechargeable battery 140, and abnormal heating of the other rechargeable batteries 140 because of heat propagation could be suppressed, by placing individual rechargeable batteries 1440 in the space vertically partitioned by fireproof insulation boards 134.

The fireproof insulation board 134 described in FIG. 1 and FIG. 2 is an effective means for abnormalities of rechargeable batteries 140 inside a rechargeable battery block 120 of one rechargeable battery storage system rack 10, but when a plurality of rechargeable battery storage system racks 10 are arranged in a row, other considerations are required in order to prevent the abnormality that occurs in one rechargeable battery storage system rack 10 from affecting another rechargeable battery storage system rack 10.

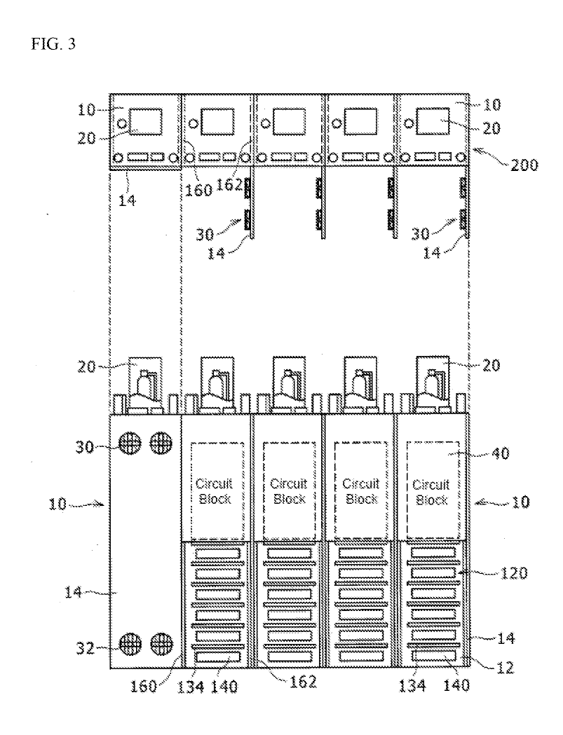

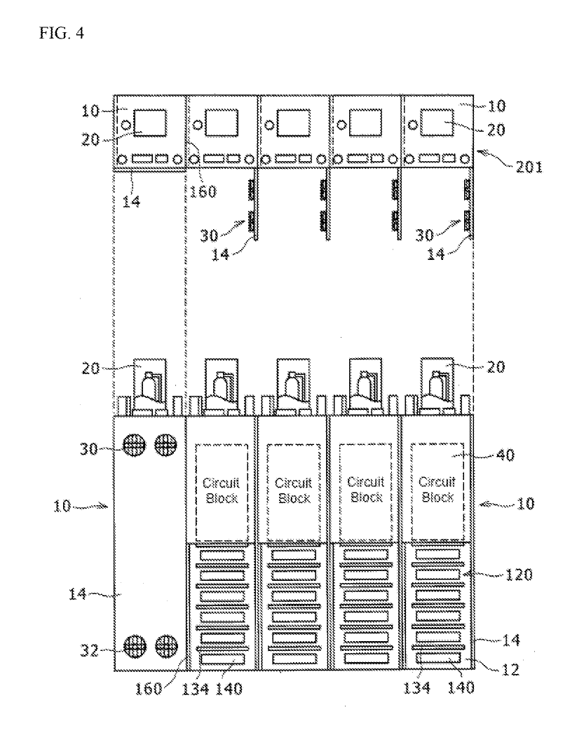

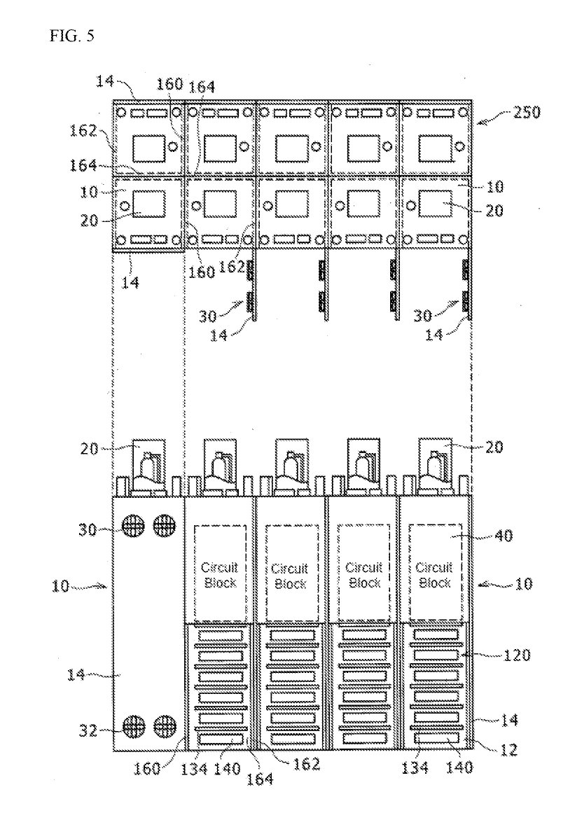

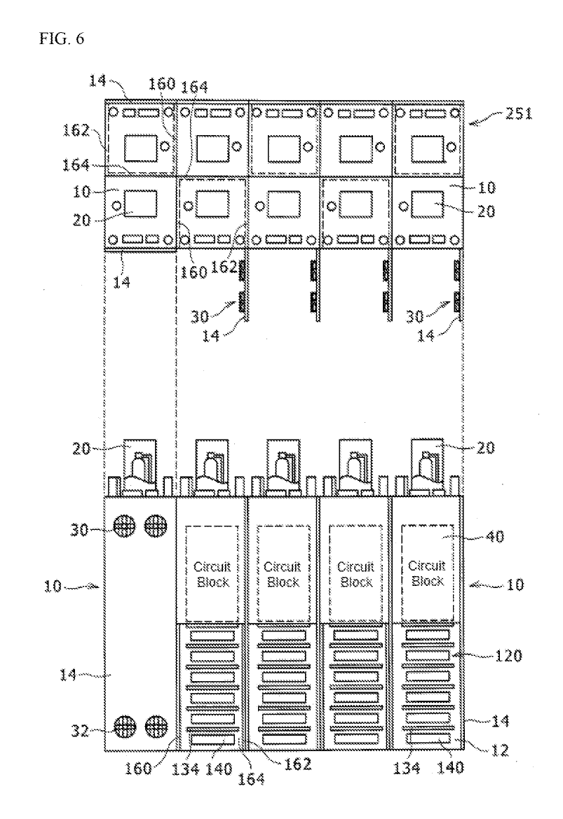

Next, the placement of the fireproof insulation board in an electrical storage system where a plurality of rechargeable battery storage system racks 10 are arranged as described in FIG. 1 and FIG. 2 is described using FIG. 3 through FIG. 6. FIG. 3 and FIG. 4 are diagrams describing the condition of placing the fireproof insulation boards when five rechargeable battery storage system racks 10 are arranged in a lateral row, and FIG. 5 and FIG. 6 are diagrams that describe the condition of placing the fireproof insulation boards when 10 rechargeable battery storage system racks are arranged either in one row or in two rows of five. These diagrams illustrate the front surface view and the top surface view similar to FIG. 1 and FIG. 2, and illustrate the condition where the front surface door is open on the five on the right-hand side and the condition where the front surface door 14 is closed on the five on the furthest left hand side on the surface of the paper, for the five rechargeable battery storage system racks that are arranged in a lateral row in the front surface diagram.

FIG. 3 is a diagram illustrating the condition of an electrical storage system 200 where five rechargeable battery storage system racks 10 are arranged in a lateral row. Herein, a fireproof insulation board 160, 162 is placed on the inner side of the contacting wall surface which is the wall surface that contacts the outer wall surface of another rechargeable battery storage system rack 10, in the storage main units 12 of each rechargeable battery storage system rack 10. Specifically, fireproof insulation board 160 is placed on the inner side of the left wall surface that contacts the outer wall surface of another rechargeable battery storage system rack 10 when the storage main units 12 of the rechargeable battery storage system racks 10 are arranged in a lateral row, and fireproof insulation board 162 is placed on the inner side of the right wall surface. Herein, the left and right directions designate the left and right directions when facing the front surface door 14 of the rechargeable battery storage system racks 10 arranged in a lateral row.

Thereby, even if an abnormality such as heating occurs in one rechargeable battery storage system rack 10, the effect on an adjacent rechargeable battery storage system rack 10 can be suppressed.

FIG. 4 is a diagram illustrating the condition of an electrical storage system 201 where a placement of the fireproof insulation boards can be partially omitted for the case where a rechargeable battery storage system rack 10 is arranged in a lateral row. In other words, for the case of FIG. 3, the fireproof insulation board 160 and the fireproof insulation board 161 are placed on the inner part of the wall surface that mutually contact in adjacent rechargeable battery storage system racks 10, excluding the right wall surface of the rechargeable battery storage system rack 10 on the farthest right and the left wall surface of the rechargeable battery storage system rack 10 on the farthest left side, of the five rechargeable battery storage system racks 10 placed in a lateral row, and thus the fireproof insulation boards are overlapping.

In the electrical storage system 201 of FIG. 4, a fireproof insulation board 160 is placed on the inner side of the left wall surface of the rechargeable battery storage system rack 10 when arranged in a lateral row, and the placement of the fireproof insulation board is omitted on the inner side of the right side surface. Even when placed in this manner, if an abnormality such as heating occurs in one rechargeable battery storage system rack 10, the effect on an adjacent rechargeable battery storage system rack 10 can be suppressed. Note, as a substitution for the configuration of FIG. 4, the fireproof insulation board 162 can be placed on the inner side of the right wall surface of the rechargeable battery storage system rack 10, and placement of the fireproof insulation board on the inner side of the left side surface can be omitted.

FIG. 5 is a diagram describing the condition for placing fireproof insulating boards in an electrical storage system 250 square 10 rechargeable battery storage system racks are arranged in two rows of five. The configuration of the electrical storage system 250 is as described below. In other words, if the outer wall surface where the front surface door 14 which is an opening and closing door of each rechargeable battery storage system rack 10 is provided is a front surface, the outer wall surface on the opposite side as the front surface is the back surface, the front surfaces of five rechargeable battery storage system racks 10 are arranged in a lateral row to form a row on one side, the front surface of another five rechargeable battery storage system racks 10 are aligned to form a lateral row on the other side, and the back surface of each rechargeable battery storage system rack 10 that form a row on one side and the back surface of each rechargeable battery storage system rack 10 that forms a row on the other side are arranged to be in contact, such that the ten rechargeable battery storage system racks 10 are arranged in two rows.

Furthermore, the placement of the fireproof insulation boards in this electrical storage system 250 is as described below. In other words, a fireproof insulation board 160 is placed on the inner side of the left wall surface, a fireproof insulation board 162 is placed on the inner side of the right wall surface, and a fireproof insulation board 164 is placed on the inner side of the back wall surface. In other words, fireproof insulation boards are placed on the inner side of each of the three wall surfaces excluding the front surface of the rechargeable battery block 120 of each rechargeable battery storage system rack 10 of the storage main unit 12 of each rechargeable battery storage system rack 10.

Thereby, even if an abnormality such as heating occurs in one rechargeable battery storage system rack 10, the effect on an adjacent rechargeable battery storage system rack 10 can be suppressed.

Note that in the example of FIG. 5, one side row is the row on the closest side, another side row is the row on the opposite side, and the back surface of each rechargeable battery storage system rack 10 that form the row on one side is configured so as to contact with exactly the same surface area as the back surface of each rechargeable battery storage system rack 10 that forms the rows on the other side.

For example, if the amount of shift is equal to half of the length in the lateral direction of one rechargeable battery storage system rack 10, the back surface of one rechargeable system battery storage system rack 10 that forms the roles on one side will be arranged so as to contact half of the back surface of two rechargeable battery storage system racks 10 that form the row on the other side. Even with this configuration, fireproof insulation boards are placed on the inner side of three wall surfaces excluding the front surface of the rechargeable battery block 120 of each rechargeable battery storage system rack 10, and therefore if an abnormality such as heating or the like occurs in one of the rechargeable battery storage system racks 10, the effect on the adjacent rechargeable battery storage system racks 10 can be suppressed.

FIG. 6 is a diagram illustrating the condition of an electrical storage system 251 where placement of the fireproof insulation boards can be partially omitted for the case where rechargeable battery storage system racks 10 are arranged in two rows. In other words, for the case of FIG. 5, fireproof insulation boards are placed on all of the inner sides of the three wall surfaces excluding the front surface for each of the rechargeable battery storage system racks 10, and thus there is an area with so-called overlapping placement.

With the electrical storage system 251 of FIG. 6, all of the fireproof insulation boards are placed on the inner side of three wall surfaces excluding the front surface to form a staggered arrangement that skips one in an angle direction for 10 rechargeable battery storage system racks 10 that are arranged in two rows, and the placement of all other fireproof insulation boards are omitted.

In other words, every other rechargeable battery storage system rack 10 in a row on one side as described in FIG. 10 is a designated rack on one side, every other rechargeable battery storage system rack 10 of the row on the other side where the back surface does not contact a designated rack on one side is a designated rack on the second side, fireproof insulation boards are placed on the inner sides of the left wall surface, right wall surface, and back wall surface which are the three outside wall surfaces excluding the front surface for the storage main unit of each rechargeable battery storage system rack 10 which are the designated racks on one side or the designated racks on the other side, and placement of fireproof insulation boards is omitted on the rechargeable battery storage system racks 10 other than the designated racks on one side and omitted on the rechargeable battery storage system racks 10 other than the designated racks on the second side.

As described in FIG. 6, the 5 closest rechargeable battery storage system racks 10 form the row on one side, and herein, the second rechargeable battery storage system rack 10 and the fourth rechargeable battery storage system rack from the left side are the designated racks on one side. The 5 furthest rechargeable battery storage system racks 10 form the row on the second side, and herein, the first rechargeable battery storage system rack 10, the third rechargeable battery storage system rack, and the fifth rechargeable battery storage system rack 10 from the left side are the designated racks on the second side. In this manner, the two designated racks on one side and the three designated racks on the second side have a so-called staggered relationship on the plane illustrated in FIG. 6.

In other words, for the two designated racks on the one side and the three designated racks on the second side, a fireproof insulation board 160 is placed on the inner side of the left wall surface, a fireproof insulation board 162 is placed on the inner side of the right wall surface, and a fireproof insulation board 164 is placed on the inner side of the back wall surface of the storage main unit 12 of each rechargeable battery storage system rack 10. In other words, fireproof insulation boards are placed on the inner side of each of the three wall surfaces excluding the front surface of the rechargeable battery block 120 of each rechargeable battery storage system rack 10.

In this regard, a fireproof insulation board is not placed on the inner side of the left wall surface nor on the inner side of the right wall surface nor on the inner side of the back wall surface of each of the rechargeable battery storage system racks 10 other than the two designated racks on the one side and the three designated racks on the second side. In other words, placement of the fireproof insulation board is omitted on the inner side of the left wall surface, on the inner side of the right wall surface, and on the inner wall of the back wall surface in the first rechargeable battery storage system rack 10 and the third rechargeable battery storage system rack 10 and the fifth rechargeable battery storage system rack 10 from the left side in the row on the one side that is the closest side in FIG. 6 Furthermore, placement of the fireproof insulation board is omitted on the inner side of the left wall surface, on the inner side of the right wall surface, and on the inner wall of the back wall surface in the second rechargeable battery storage system rack 10 and the fourth rechargeable battery storage system rack 10 from the left side in the row on the second side that is the furthest side in FIG. 6.

Even when placed in this manner, if an abnormality such as heating occurs in one rechargeable battery storage system rack 10, the effect on an adjacent rechargeable battery storage system rack 10 can be suppressed. Note, as an alternate to the configuration of FIG. 6, the rechargeable battery storage system racks 10 that are not designated racks can be designated racks, and the rechargeable battery storage system racks 10 that are designated racks can be not designated racks. Even with this configuration, the designated racks will be positioned in a so-called staggered configuration, and the same effects as FIG. 6 can be demonstrated.

### POSSIBILITY OF INDUSTRIAL APPLICATION

The electrical storage system of the present invention can be used as a rechargeable battery storage device that internally stores a circuit device and a plurality of rechargeable batteries.

### DESCRIPTION OF SYMBOLS

10 rechargeable battery storage system rack

12 storage main unit

14 front surface door

20 fire extinguishing device

30 ventilation fan

32 intake fan

40 circuit block

120 rechargeable battery block

134, 160, 162, 164 fireproof insulation board

140 rechargeable battery

200, 201, 250, 251 electrical storage device

What is claimed is:

1. An electrical storage system with a plurality of rechargeable battery storage system racks containing rechargeable batteries and a circuit block that controls charging and discharging of the rechargeable batteries; wherein
each of storage main units of the rechargeable battery storage system racks that compose the plurality of rechargeable battery storage racks that are arranged has a plate material placed by a predetermined placement method on an inner side of a contacting wall surface which is a wall surface of the rechargeable battery storage system rack that contacts the outer wall surface of a second rechargeable battery storage system rack that is adjacent to the rechargeable battery storage system rack.

2. The electrical storage system according to claim 1, wherein the predetermined placement method includes placing the plate material on the inner side of any one of the contacting wall surfaces that are outside wall surfaces that mutually contact between adjacent rechargeable battery storage system racks, and omitting placement of the plate material on the inner side of the contacting wall surface of the storage main unit of the second rechargeable battery storage system rack.

3. The electrical storage system according to claim 2, wherein the storage main unit of each rechargeable battery storage system rack has the plate material on one of either the inner side of the left wall surface or the inner side of the right wall surface adjacent to the outer wall surface of the second rechargeable battery storage system rack when placed in a lateral row, for the case where the plurality of rechargeable battery storage system racks are arranged in a lateral row.

4. The electrical storage system according to claim 2, wherein
if an opening and closing door is provided on one of the four outer wall surfaces of each rechargeable battery storage system rack, the outer wall surface where the opening and closing door is provided is a front surface, the outer wall surface on the opposite side as the front surface is the back surface, the front surfaces of a plurality of rechargeable battery storage system racks are arranged in a lateral row to form a row on one side, the front surface of the other plurality of rechargeable battery storage system racks are aligned to form a lateral row on the other side, and the back surface of each rechargeable battery storage system rack that form a row on one side and the back surface of each rechargeable battery storage system rack that forms a row on the other side are arranged to be in contact, such that the plurality of rechargeable battery storage system racks are arranged in two rows;
every other rechargeable battery storage system rack in a row on one side is a designated rack on one side, and every other rechargeable battery storage system rack in the row on the other side which does not contact on the back surface to the designated rack on the one side is a designated rack on the other side; and a storage main unit part of each rechargeable battery storage system rack that includes the designated racks on the one side and the designated racks on the other side?
has a plate material placed on the inner side of the back wall surface, the left wall surface, and the right wall surface, which are the three outer wall surfaces excluding the front surface.

5. The electrical storage system according to claim 1, wherein
if the plurality of rechargeable battery storage system racks are arranged in a lateral row,
the storage main unit of each rechargeable battery storage system rack has the plate material on the inner side of the left wall surface, and the inner side of the right wall surface adjacent to the outer wall surface of the second rechargeable battery storage system rack when placed in a lateral row.

6. The electrical storage system according to claim 1, wherein
if an opening and closing door is provided on one of the four outer wall surfaces of each rechargeable battery storage system rack, the outer wall surface where the opening and closing door is provided is a front surface, the outer wall surface on the opposite side as the front surface is the back surface, the front surfaces of a plurality of rechargeable battery storage system racks are arranged in a lateral row to form a row on one side, the front surface of the other plurality of rechargeable battery storage system racks are aligned to form a lateral row on the other side, and the back surface of each rechargeable battery storage system rack that form a row on one side and the back surface of each rechargeable battery storage system rack that forms a row on the other side are arranged to be in contact, such that the plurality of rechargeable battery storage system racks are arranged in two rows,
the storage main unit of each rechargeable battery storage system rack
has a plate material placed on the inner side of) the back wall surface, the left wall surface, and the right wall surface, which are the three outer wall surfaces excluding the front surface.

7. The electrical storage system according to claim 1, wherein the plate material is a flameproof insulation plate.

8. The electrical storage system according to claim 7, wherein the flameproof insulation plate is a calcium silicate plate.

9. A rechargeable battery storage system rack, comprising:
a rechargeable battery;
a circuit block that controls charging and discharging of the rechargeable battery; and
a storage main unit that stores the rechargeable battery and the circuit block, wherein an opening and closing door it is provided in one of the four outer wall surfaces, the outer wall surface where the opening and closing door is provided is the front surface, the outer wall surface on the opposite side as the front surface is the back surface, the outer wall surface on the left side when facing the front surface is the left wall surface, and the outer wall surface on the right side when facing the front surface is the right wall surface, and the plate material is provided on the inside of at least one outer wall surface of the back wall surface, left wall surface, and right wall surface.

10. The rechargeable battery storage system rack according to claim 9, wherein the storage main unit has the plate material provided on either one of the inner side of the left side surface or the inner side of the right wall surface.

11. The rechargeable battery storage system rack according to claim 9, wherein
the storage main unit has the plate material placed on the inner side of the back wall surface, the left wall surface, and the right wall surface, which are the three outer wall surfaces excluding the front surface.

12. The rechargeable battery storage system rack according to claim 9, wherein the plate material is a flameproof insulation plate.
